(19) United States
(12) Patent Application Publication
(10) Pub. No.: US 2003/0091270 A1
(43) Pub. Date: May 15, 2003

(54) Closed-loop control of MEMS mirrors for optical communications

(76) Inventors: Eric C. Abbott, North Bend, WA (US); Randall B. Sprague, Carnation, WA (US); Michael Logan, Woodinville, WA (US)

Correspondence Address: LUMEN INTELLECTUAL PROPERTY SERVICES, 45 CABOT AVENUE, SUITE 110, SANTA CLARA, CA, 95051, US

(21) Appl. No.: 10/254,436

(22) Filed: Sep. 23, 2002

(51) Int. Cl. G02B 6/35; G02B 7/182

(52) U.S. Cl. 385/18; 385/147; 359/871

(57) ABSTRACT

A control system for a moveable mirror array in an optical cross connect (OXC) compensates for non-linear actuation charge response, actuation leakage, asymmetry in the derivative driving scheme of the electrostatic actuated mirror and its driving circuitry. In addition zero-crossing is resolved with a near-zero algorithm or a off-zero algorithm, which are alternately applied whether or not the mirror's target orientation is within a critical threshold. The threshold is defined as an ambiguous orientation range of the mirror while the actuating electrodes are substantially at zero charge. The control system includes an optical feedback loop that utilizes a PDA detector that provides coordinate information about an impinging laser injected into the optical telecommunication signals switched by the OXC. The laser is filtered from the reflected beam prior to its impinging on the detector. The telecommunication signal remains substantially unaffected by the optical feedback loop.

### CROSS REFERENCE

The present invention cross references the U.S. application Ser. Nos. 09/999,610 filed Oct. 24, 2001, 09/999,878 filed Oct. 24, 2001, 09/999,705 filed Oct. 24, 2001, 09/894,021 filed Jun. 27, 2001, 10/003,659 filed Oct. 24, 2001, 10/002,310 filed Oct. 24, 2001, 09/779,189 filed Feb. 7, 2001, and U.S. application titled “High Speed Photodetector System Using a PIN Photodiode Array For Position Sensing” by R.Sprague filed Jun. 4, 2002, all of which are herein incorporated by reference.

### FIELD OF INVENTION

The present invention relates to control systems of electro statically actuated micro-electromechanical systems (MEMS). Particularly, the present invention relates to a control system for MEMS mirrors of an optical crossconnect (OXC).

### BACKGROUND OF INVENTION

The increasing utilization of fiber optic networks puts pressure on the industry to develop more compact and efficient components. Generally speaking, voice and data communications travel from their source to their destination encoded in digital form by means of an optical medium. The optical signals that carry voice and data traffic travel in optical fibers. These optical fibers usually do not run directly from the signal's source to its destination. Rather, the signal runs through a fiber from the source through one or more switching hubs that redirect the signal from the source fiber to a different fiber. Transmission of the optical signal to its destination is achieved by repeatedly redirecting the signal toward its destination with such switches.

Criteria that define the efficiency of such optical switches are switching speed, switching reliability, number of simultaneously switchable propagating signals, and minimal signal attenuation and distortion. An advantageous switching device in that context is an optical crossconnect (OXC) that is capable of simultaneously switching a large number of optical telecommunication signals. In an OXC, optical fibers are bundled into two groups. Depending on the direction the telecommunications signals are traveling one group is referred to as incoming fibers and the second group is referred to as outgoing fibers. Telecommunications signals travel from their source to the OXC's incoming fiber port, and the OXC directs the signal on each incoming fiber to a corresponding outgoing fiber in the outgoing fiber port. In general, an OXC can pass the signal from any incoming fiber to any outgoing fiber.

One means by which an OXC can direct signals from an incoming fiber to an outgoing fiber is by reflecting the telecommunications signal off of one or more intervening mirrors. The most general form of OXC can pass the telecommunications signal from any incoming fiber to any outgoing fiber. However, to achieve this, the mirrors inside the OXC must be able to move, and their position must be held with extremely good stability in order to maintain adequate connection between an input-output fiber pair. Usually, densely arrayed and electrostatically actuated MEMS mirrors are utilized for that purpose.

For example, U.S. Pat. No. 6,396,976 to Little, et al. describes such an array of MEMS mirrors that are actuated and balanced by two separate electrodes by means of inducing electrostatic forces onto the mirrors. The positioning control in that system is accomplished either by mechanical stops or by a generic closed loop control system. No specific control system is disclosed that takes into account the requirements affiliated with fast positioning and reliable position holding of the MEMS mirrors.

In U.S. Pat. Appl. Publ. No. 2001/0032508 to Lemkin, et al. a position sense interface is disclosed that uses a differential charge integrator with input-sensed output-driven common mode feedback derived from specifically configured sense capacitors. The interface may be used for motion and position control of electrostatically-actuated MEMS mirrors. The invention is limited to single pole charges applicable to micro actuators and does not take into account the specific controller needs for a MEMS mirror chip with integrated logic circuitry. Particularly, the use of sense capacitors is unfavorable due to their power consumption and additional space requirements.

Finally, U.S. patent application Publ. No. 2002/0106144 to Garverick, et al. describes a multiplexed analog control system for a MEMS mirror of an optical switch. The controller utilizes a feedback loop including an optical detector to generate a bipolar driving signal that is applied to the electrostatic microactuators. Several parameters are set during a factory calibration and stored in the controllers memory to compensate for well-known current leakage, disproportional actuator response, and other degrading hardware influences in the involved electronic circuitry and the electro mechanical and mechanical structure. The charges are applied to the microactuators incrementally in symmetrically opposing sets of two. That means, one microactuator is always charged while an opposing actuator is discharged by the same charge amount. A reinitialization signal zeroes the microactuators periodically in dependence on a droop rate at which the mirrors position becomes uncontrollable due to current leakage in the involved circuitry. The refresh rate is disclosed as at least once per second. The controller further distinguished between coarse and fine mirror adjustments and applies different control algorithms. The controller operates in a 6 or 8-bit mode, which produces a resolution of better than 1%.

The disclosed control system represents a vague disclosure of the control system. Issues related to optical feedback remain unclear. An optical monitoring system is described as splitting off a portion of the telecommunication signal to derive information about the positioning accuracy of the mirrors. This is an unfavorable solution since it reduces the optical transmission efficiency of the device.

In summary, the control system disclosed by Gaverick is insufficient for simultaneously controlling more than 2000 mirrors with a simultaneous positioning speed of less than 8 msec for each mirror, an angular resolution of less than 0.01 degree, a tilt range of 16 degree per mirror and axis, a vibration compensation capability of up to 0.1 g at 100 Hz. These are exemplary controller requirements for which the need exists in order to operate a device as described in the cross-referenced applications listed above.

A number of control challenges need to be mastered to meet or even exceed the above controller requirements. In addition, the need for miniaturization of the involved components imposes additional issues that need to be resolved by the controller.

One issue relates to the electrostatically-actuated mirrors preferably implemented in an OXC. This actuation mechanism, while very practical for MEMS mirrors, is non-linear in nature and more difficult to solve than linear control problems. The mirrors are preferably made from silicon and plated with a highly reflective coating. Under each mirror surface is a mechanical structure that causes the mirror surface to tilt in either or both of two orthogonal tilt axes. Prior art FIG. 1 shows a simplified schematic front view of a mechanism built on a substrate 10 including the mirror and the main components involved in actuating the mirror. The actuation mechanism depicted in FIG. 1 is for one tilt axis only. A second actuation mechanism of similar configuration is placed perpendicular to the view direction. For each tilting axis, there are preferably two beam structures 17 pulled by opposing electrodes 16, 19. The beam structures 17 pivot around the hinges 18 and connect to the mirror body 12 via the connecting structures 13 such that a swaying movement of the beam structures 17 is transformed into a positive or negative tilt movement of the mirror surface 11. An electrostatic pulling force occurs between the beam structures 17 and the electrodes 16, 19 in dependence on a voltage applied to the electrodes 16, 19.

From the point of view of closed-loop control, an important feature of the mirror is its dynamic behavior—i.e. the movement of the mirror in response to an actuation signal. Dynamically, each axis of the given mirror exhibits two primary modes and can be accurately modeled as a 4^{th} order system.

The mirror's dynamics can be characterized by the mirror's time domain and frequency domain responses to actuation inputs. For example, prior art FIG. 2 shows well-known Bode magnitude plots for one axis of an exemplary mirror (solid curve 20) and for a model of that exemplary mirror (dotted curve 21). This plot shows the magnitude of the mirror's rotational response as a function of the frequency of the actuation signal. As the FIG. 2 shows, the model of the mirror accurately replicates the dynamic properties of the exemplary mirror. The Bode plot supplies the primary characterization of the mirror.

The dynamics of the mirror are determined by the mass properties of the reflective surface and the kinematical properties of the underlying mechanical structure. The dynamics of the mirror are largely communicated by the locations and magnitudes of the resonant peaks shown in the Bode plot. These mirror characteristics greatly influence the design of the controller. They may be predicted through modeling and can be measured.

FIG. 2 is a frequency-domain representation of the mirror's behavior. A more complete picture of the mirror's behavior includes its time-domain response. FIG. 3 shows the mirror's response to a step change in its input voltage applied to one of the electrodes 16 or 19.

As curve 30 shows in prior art FIG. 3, the mirror responds to a step in voltage with a large overshoot—approximately twice the final value—and a long period of ringing decay. The mirror exhibits this behavior because the modes are lightly damped, which is also suggested by the peaks in the previous Bode plot.

FIG. 3 illustrates that a preferably utilized mirror and mechanism rings for more than 100 msec. For comparison, preferred system requirements may dictate that the closed-loop control system cause the mirror to achieve its final position within 8 msec to an accuracy of 0.01 degree with 10% overshoot or less. Therefore, there exists a need for a control system that applies an actuation charge to electrodes 16 and/or 19 in a fashion such that the above preferred system requirements are met.

The nature of electrostatic attraction between the electrodes 16, 19 and the beam structures 17 is nonlinear because the relationship between the applied electrode voltage and the resulting mirror angle is nonlinear. From the point of view of the controller, the nonlinearity is exhibited as a nonlinear increase in the mirror's response to an actuation charge as a function of the mirror's angle. In other words, the ratio of the mirror's angular response to a change in electrode voltage is a function of mirror angle. At very small angles, the mirror moves very little in response to a change in electrode voltage. At larger angles, the mirror is much more sensitive to the same change in electrode voltage. The extent to which the mirror's actuation charge response changes as a function of angle depends on specific mechanical characteristics of the mirror.

Prior art FIG. 4 shows an exemplary factor increase in actuation charge response for one axis of a preferred mirror versus voltage on the mirror's electrode. As the curve 40 shows, the charge response of the mirror at high voltages (i.e. at high angles) may be 50 to 60 times larger than at small voltage. Therefore, there exists a need for a control system that applies an actuation charge to electrodes 16 and/or 19 in correspondence to the mechanism's non-linear actuation charge response.

In addition to the nonlinear behavior inherent in electrostatic actuation, there are other issues that make mirrors more difficult to control. One example of this is the means by which voltage is developed at the electrodes.

Although a mirror's position is set by the voltage on its electrodes, system software cannot set the electrode voltage directly. Instead, the actuator electronics require that software command positive or negative changes to each electrode voltage to adjust the mirror's position. The reason for having a scheme that commands voltage changes is dictated by practical issues related to integrating the electronic drive with the MEMS mirror. The advantage of having this derivative scheme is that the circuitry required to implement it is very small in comparison to that required for direct voltage drive. Although this design has tremendous practical advantages, this drive scheme makes the control problem more difficult. The reason for this is that the actuator is, in effect, an integrator that sums up commands for changes in voltage.

An exemplary driving circuit used for applying and holding derivative actuation charges on the electrodes 16, 19 is shown in prior art FIG. 5. A control electronics 51 receives a voltage change command 50 and switches correspondingly either or both transistors 53, 55, which either add or subtract a charge to a hold capacitor 54 and the electrodes 16 respectively 19, which exhibit in combination with the beam structures 17 well-known characteristics similar to that of a capacitor. The actual voltage levels in the hold capacitor and electrodes 16, 19 remain unknown. Direct measurement of the charges is infeasible since the measurement itself would alter the relatively small charges. Control issues that arise particularly in combination with such derivative driving scheme are position sensing of the mirrors, actuator leakage, actuator asymmetry, and a zero-crossing problem described below.

Position sensing is difficult in a derivative driving scheme because there are no reliable parameters in the electric path of the driving circuitry that may be utilized to derive feedback about the mirrors position. Attempts in the prior art to read the voltage on the mirror electrodes required relatively large charges that remain unaffected by the measurement. To the contrary, demands for miniaturization in the actuation mechanism and the driving circuitry reduce the charges to levels where their measurements are difficult to accomplish. That is, because the capacitance of the output capacitor is so small that any attempt to measure the voltage across it results in rapidly discharging it. Another attempt in the prior art is to read the signal strength of the output optical signal as parameter for fine-tuning the mirrors position around discrete predetermined mirror orientation. Such approach proves insufficient where more than 2000 orientations have to be provided over an angular range of 16 by 16 degrees. Reading the signal strength as parameter does not provide for precise position information. Fine adjusting a mirror with such a feedback is time consuming and inaccurate.

Actuator leakage arises, because the circuit elements are not ideal and the voltage potential on the capacitor 64 is not constant. This drift in voltage across the capacitor is referred to as leakage.

Another manner in which the actuator behavior is non-ideal is in the form of actuator scale factor asymmetry. Scale factor asymmetry arises because the circuit that charges the electrode capacitor is different than the circuit that discharges the electrode capacitor. Mismatches in the components of the two circuits cause the scale factor of the two circuits to differ from one another. As a result, increases and decreases in electrode voltage do not have the same magnitude, even if the magnitude of the commanded voltage change is the same in both cases. Generally speaking, these scale factor variations have a strong deleterious effect on the stability of the closed-loop mirror position. As the mismatch between voltage increases and decreases becomes greater, the steady-state mirror position instability also becomes greater.

There is another problem that arises as a result of using a derivative drive scheme. This problem is referred to as the zero-crossing problem. The zero-crossing problem arises also because the voltage on the mirror electrodes is not known. Not knowing or having direct control over the electrode voltage becomes problematic under two circumstances: 1.) when the desired movement of the mirror requires crossing from one side of zero angle to the other side (e.g. switching from a negative angle to a positive angle) and 2.) when the mirror's target position is near zero angle.

In case a mirror needs to be moved from a positive angle to a negative angle, then the voltage on the positive electrode must first go to zero volts, and the voltage on the negative electrode must then begin to increase. This switch from one electrode to another must occur seamlessly in order to avoid a transient disturbance in the mirror's position. Since the voltage levels on the electrodes 16, 19 are unknown, the control algorithm does not know when to switch from one electrode to another. This problem is deceptively difficult to solve and has proven to be one of the thorniest of all of the control challenges. The sign convention for “positive” and “negative” angles is arbitrary.

Therefore, there exists a need for a control system for a derivative driving scheme that resolves the problems affiliated to position sensing, actuator leakage, actuator scale factor asymmetry and zero-crossing. The present invention addresses this need.

### Summary

In an optical cross connect (OXC), a control system is implemented that accommodates for the design specifics of a highly miniaturized moveable mirror array with an integrated actuation mechanism and integrated driving circuitry.

To compensate for the non-linear actuation charge response of the mechanism actuating the mirrors, a charge response calibration is performed prior to operation of the OXC. In a lookup table the processed calibration data is stored and made available during device operation. A position command directed to a controller is adjusted by a corresponding factor taken from the lookup table.

Position sensing is accomplished by introducing an optical feedback loop that utilizes a well-known optical PDA sensor that produces an impinging coordinate information of beams reflected by the mirror. The beams are preferably laser injected into the fiber and substantially collinear propagating together with optical telecommunication signals that are switched by the mirrors. The laser is configured such that it is filtered from the telecommunication signal without substantially degrading or attenuating the telecommunication signal. The impinging coordinate is computed by the control system to provide quick and precise information of the mirrors' spatial orientation. A short laser pulse is applied to each mirror of the mirror array during each refresh interval such that each mirror's orientation is determined and eventually adjusted within the mirror array.

Actuator leakage is handled by the control system by measuring the leakage of each mirror electrode in a calibration process. In real time operation, software adds a correction to every actuation charge that it sends out to the electrode. This correction is an additional voltage that is equal and opposite to the leakage as measured in the calibration process.

Actuator scale factor asymmetry is compensated by performing an asymmetry calibration during which a set charge and an opposing reset charge in the same amount is periodically and alternately applied to the electrodes 26, 29. Eventual driving scheme asymmetry results in a gradual tilt of the mirror around the axis at which the calibration is performed. The tilt movement is recognized and an asymmetry compensation factor computed and applied such that the tilt movement stops. The compensation factor is then applied during device operation.

Zero-crossing is resolved by the control system by applying an off-zero actuation algorithm or a near-zero actuation algorithm in dependence of the mirrors target position. A movement range threshold is defined for each mirror where drift in the position sensing occurs over minutes and days during the operation of the OXC. Slack occurs while said electrostatic actuator is substantially without charge. In the case where the target position is within the threshold, the near-zero algorithm is executed as soon as the mirror's actual position comes within the threshold. In the contrary case where the target position is outside the threshold an off-zero algorithm is executed.

### BRIEF DESCRIPTION OF THE FIGURES

Prior Art FIG. 1 shows a schematic front view of an actuation mechanism for electrostatic actuation of a mirror along one tilt axis.

Prior Art FIG. 2 illustrates well-known Bode magnitude plots for a modeled and measured actuation mechanism as depicted in FIG. 1.

Prior Art FIG. 3 depicts a response of an exemplary mirror as depicted in FIG. 1 to a step change in its input voltage applied to one of the electrodes.

Prior Art FIG. 4 shows an exemplary factor increase in actuation charge response for one axis of a preferred mirror versus voltage on the mirror's electrode.

Prior Art FIG. 5 illustrates an exemplary driving circuit used for applying and holding derivative actuation charges on the electrodes of the actuation mechanism.

FIG. 6 depicts an exemplary configuration of a control system for an optical crossconnect in accordance with the preferred embodiment of the invention.

FIG. 7 shows a control scheme for gain scheduling by use of a lookup table.

FIG. 8 schematically depicts the effect of actuator leakage compensation.

FIG. 9a, 9b illustrate the process of actuation asymmetry calibration.

FIG. 10a, 10b show two cases of zero-crossing during mirror positioning.

FIG. 11a, 11b depict simplified exemplary charge curves for a negative positioning movement of a mirror into a positive target position within the critical threshold.

FIG. 11c, 11d illustrate simplified exemplary charge curves for a positive positioning movement of a mirror into a positive target position within the critical threshold.

FIG. 12 shows an exemplary mirror response curve resulting from a control system of the present invention.

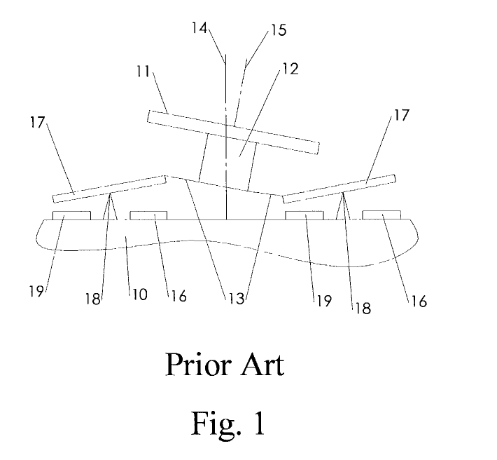

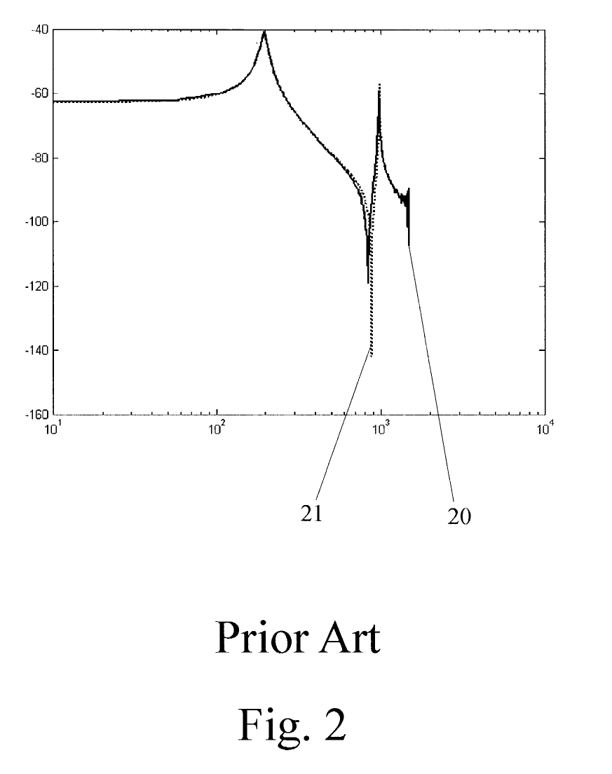

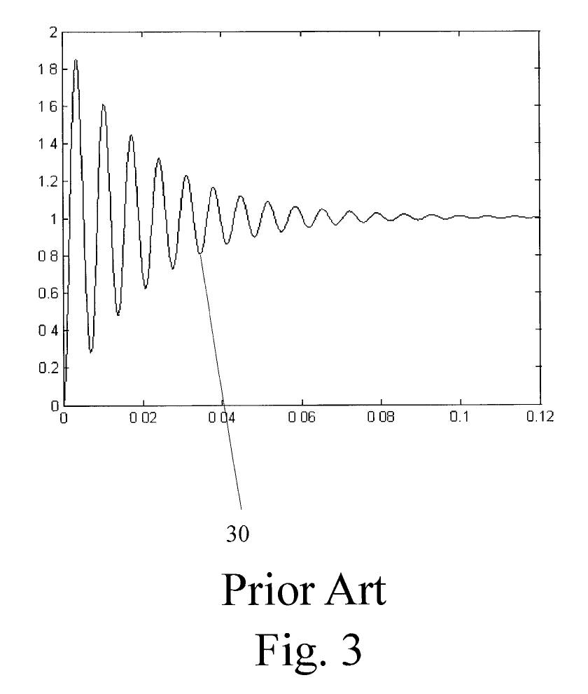

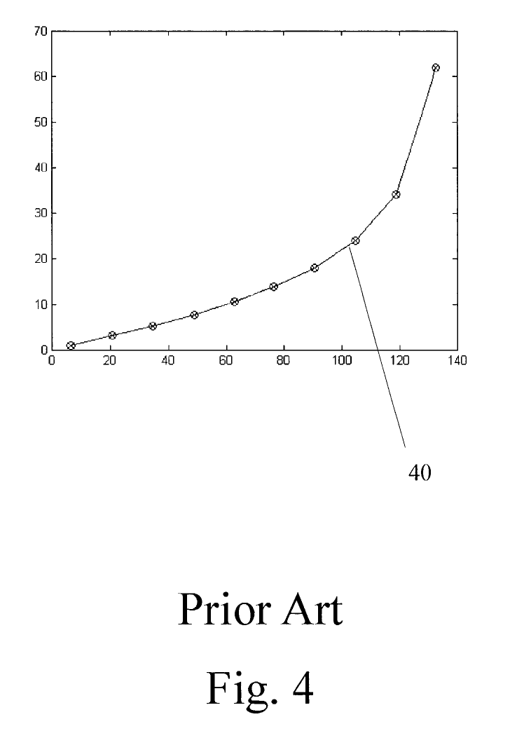

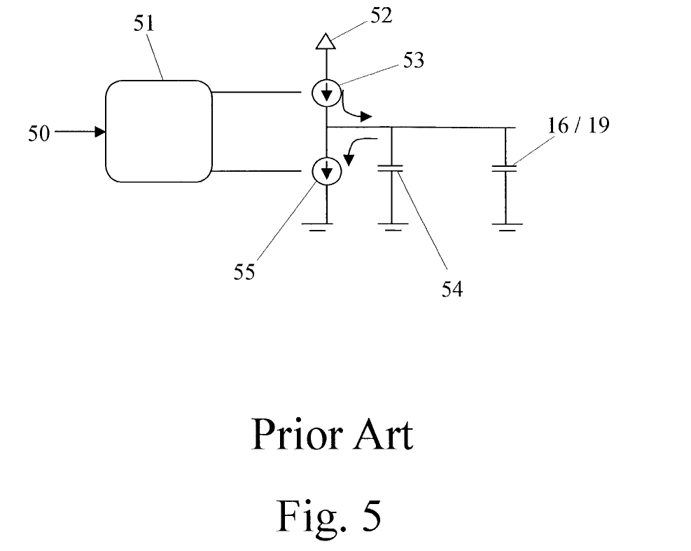

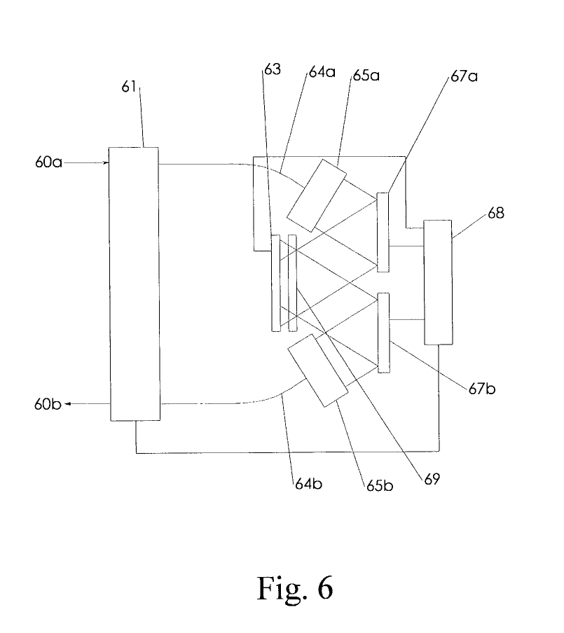

### DETAILED DESCRIPTION OF THE INVENTION

FIG. 1 depicts schematically an OXC for which the control system of the present invention is preferably configured. The OXC includes a bundle of incoming fibers 60a that pass through a laser card 61 where preferably a 980-nanometer light is injected into the same fibers 64a where optical telecommunication signals propagate towards a fiber block 65a. There, a number of laser beams emit substantially collinear with their respective telecommunication signals and impinge a mirror array 67a. Each impinging beam is independently reflected by a moveable mirror arrayed in the mirror array 67a towards a dichroic flat 69 that operates as a beamsplitter. The injected laser passes through the beamsplitter onto an optical PDA detector 63 whereas the optical telecommunication is reflected towards the mirror array 67b where individually directed beams are brought into parallel orientation and aligned with optical fibers 64b of the fiber block 65b. The outgoing fiber string 64b passes again through the laser card 61 where laser light is injected against the propagation direction of the telecommunication signal and is reflected by the mirrors of mirror array 67b, filtered and terminates on the PDA detector 63 in the same way as described for the incoming signal side of the OXC.

The OXC for which the control system is preferably configured, contains two arrays of mirrors 67a, 67b; each mirror array 67a, 67b may contain 1200 individual mirrors, and each mirror can rotate in two axes independently in a range of −8 degrees to +8 degrees. The mirrors themselves are made from silicon and are plated with a highly reflective coating. Under each mirror surface is a mechanical structure that causes the mirror surface to rotate in either or both of two orthogonal axes when actuated. FIG. 2 shows a simplified schematic diagram of the mirror's mechanical structure and actuators. To switch beams between the mirrors of the mirror arrays 67a, 67b each mirror is positioned with an accuracy of at least 0.01 degree. To accomplish this, the detector 63 provides coordinate information for each impinging laser beam reflected by a mirror in correspondence to its spatial orientation. A processor 68 computes the actual mirror orientation from the impinging coordinates. By injecting a laser into both the incoming and outgoing fibers the optical telecommunication signal remains substantially unaffected by the optical feedback loop.

The detector 63 is a critical component to the closed-loop positioning system for measuring each mirror's angular position in two axes. This device is a PIN diode array (PDA). The PDA is a rectangular semiconductor device that can measure the x-y location of a spot of light that is incident upon it. To measure the position of a given mirror, a laser beam is reflected off of the mirror and onto the PDA. The x-y location of the light on the PDA is then measured and used in the control algorithm as a representation of the angular position of the mirror.

The closed-loop control architecture of the present invention is capable of simultaneously controlling the angular position of at least 2400 mirrors. Preferably, only one sensor 63 is used to measure the position of all 2400 mirrors in the OXC. The control loop's sample/update rate is preferably 10 kHz, which means that the PDA must be capable of measuring the position of all 2400 mirrors in 100 microseconds. To achieve this, a time division multiple access (TDMA) scheme is used. In this scheme, each mirror is assigned a unique timeslot during each 100-microsecond period. During a given mirror's timeslot, which is only 40 nanoseconds long, the laser that is aimed at a given mirror is pulsed. During the laser pulse, the light reflects off of the mirror and impinges on the PDA. The PDA reads the x-y position of the light beam and forwards this information as the position of the mirror during that sample period. This position measurement serves as feedback to the controller. Using this scheme, the x-y position of every mirror in both arrays is measured at 10 kHz.

The dichroic flat 69 reflects the vast majority of the telecommunications signal, and, because of this, it never reaches the PDA. Rather, the 980-nm laser light that is injected into both the incoming and outgoing fibers is detected by the PDA. There is one 980-nm laser for each mirror—2400 in all.

The control system determines also a number of calibration parameters during calibration procedures executed prior to operation of the OXC. During the calibration, a number of tasks are commanded by the processor 68 as is described in more detail below.

To compensate for nonlinearity of the actuation charge response, the control system utilizes a simple technique known as gain scheduling. Thererby, the gain of the controller is modified in real time based on the mirror's current position. The controller's gain is varied in such a way as to invert the changes in the mirror's gain that naturally occur as a function of mirror angle.

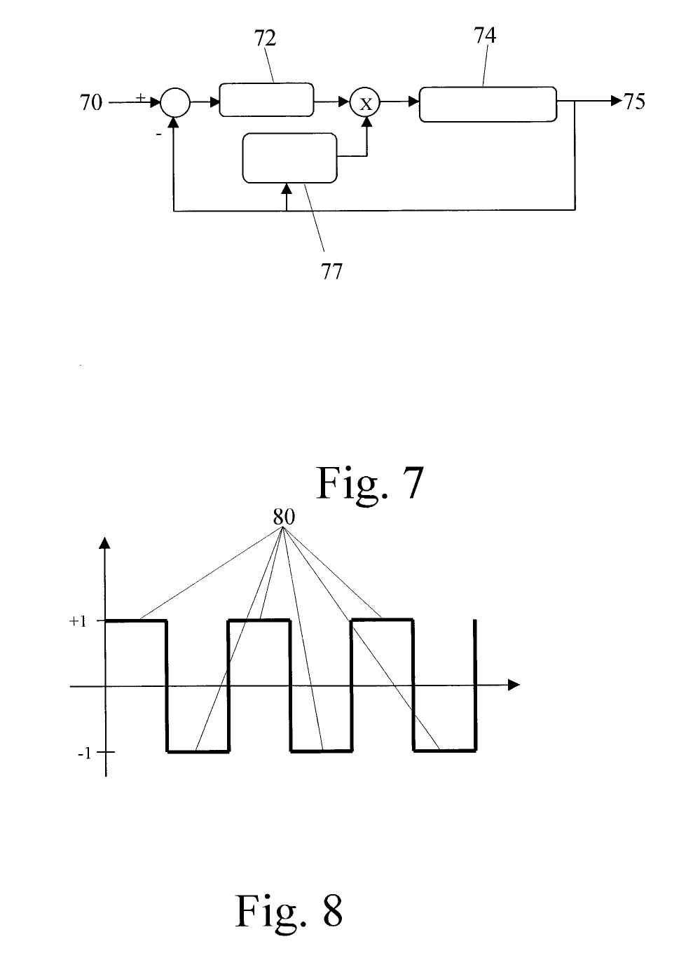

This variable gain scheme is implemented as shown in FIG. 7. First, each mirror's 74 increase in gain is measured as a function of mirror angle through a simple calibration process. This information 75 is then used to compute the required inverting controller gain. The schedule of controller gains is stored in a lookup table 77 that resides in computer memory that is available during real-time operation. At each timestep during real-time operation where a position command 70 is received by the controller 72, the mirror's actual orientation information 75 is used to index into the table 77 and to identify the gain that should be applied to the next command generated by the controller 72. The controller 72 may be part of the processor 68. By implementing gain scheduling, the nonlinearity effectively vanishes, making a linear controller suitable for use with the mirror.

Now referring to FIG. 5 and FIG. 8, it is described how the system compensates for actuator leakage of the drive circuitry. The sources of the leakage are the transistors 63, 65 shown in FIG. 5, which produce non-zero charging or discharging currents. This means that the circuit will charge or discharge the capacitor 54 e.g. 16/19 without being commanded to do so. The nature of the charging/discharging is such that it results in a linear increase or decrease in the electrode voltage as a function of time, which would cause the flat portion 80 of the charge curve to incline or decline in a fashion unknown to the control system.

Exemplary charge/discharge rates may range from zero to 2500 volts/second. This implies that between every sample taken by the digital control system, which may preferably operate at 10 kHz, the voltage on the electrodes may change by as much as 0.25 volts. This error in voltage is significant.

This leakage has an impact that cannot be ignored. The solution to this problem is to measure the leakage of each mirror electrode in a calibration process. In real time operation, software adds a correction to every command 50 such that the actuation charge is brought to a level that compensates for the occurring leakage. The leakage is measured in a calibration process.

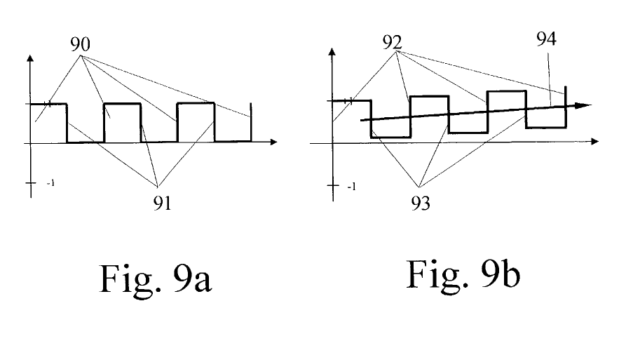

Turning to FIG. 5 and FIGS. 9a and 9b it is described how the system compensates for actuator asymmetry of the drive circuitry. Scale factor asymmetry arises because the circuit that charges the electrode capacitor is different than the circuit that discharges the electrode capacitor 16/19. Mismatches in the components of the two circuits cause the scale factor of the two circuits to differ from one another. As a result, increases and decreases in electrode voltage do not have the same magnitude, even if the magnitude of the commanded voltage change is the same in both cases.

Generally speaking, these scale factor variations have a strong deleterious effect on the stability of the closed-loop mirror position. As the mismatch between voltage increases and decreases becomes greater, the steady-state mirror position instability also becomes greater. To mitigate these deleterious effects, the asymmetry is quantified through a calibration procedure. The calibration procedure quantifies the asymmetry by commanding changes in voltage as shown in FIG. 9a by alternately applying set commands 90 and opposing reset commands 91.

As FIG. 9a shows, the software commands an increase in voltage and an equal decrease in voltage. Ideally, the voltage on the electrode would be a square wave corresponding to that shown in FIG. 9a. However, because the actual electrode's charge/discharge scale factors are not identically equal, the voltage on the electrode 16, 19 will increase or decrease at a rate proportional to the difference in scale factors, as shown in FIG. 9b.

The slope 94 of the increase or decrease in voltage, as shown by the arrow in FIG. 9b, is related to the asymmetry in the actuator—the higher the slope, the larger the scale factor mismatch between the actuators. The product of the calibration procedure is a measure of this slope 94; a single correction factor is computed from the slope 94 that can be applied to voltage commands to compensate for the mismatch.

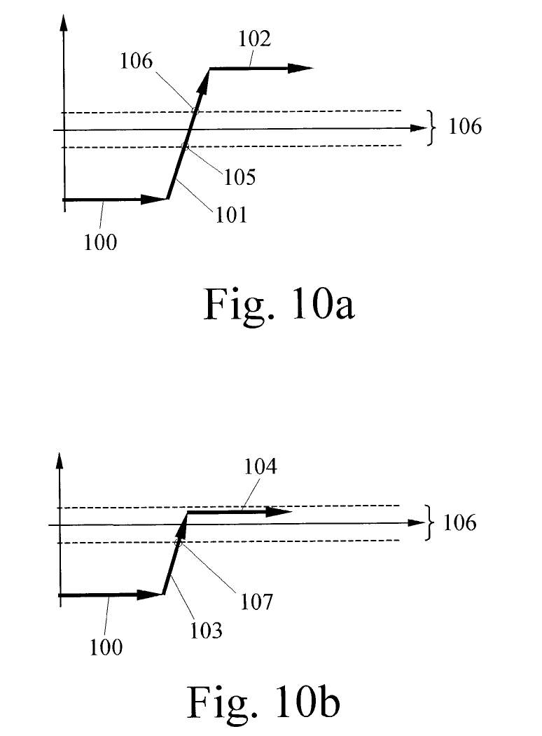

Now the control system's handling of the zero-crossing problem is described by referring to FIGS. 10a, 10b. The part of the control architecture that manages the electrode voltages near zero is referred to as the zero-crossing algorithm. The zero-crossing algorithm is invoked under the two circumstances. 1.) when the desired movement of the mirror requires crossing from one side of zero angle to the other side (e.g. switching from a negative angle to a positive angle) and 2.) when the mirror's target position is near zero angle. The first situation (i.e. the desired movement of the mirror requires crossing from one side of zero angle to the other side) is relatively simple to handle, while the second situation is more complex. In both cases, the algorithm is invoked when the electrode voltages for a given mirror axis are believed to be near zero volts. However, the manner in which the two situations are handled by the control system is considerably different.

As has been mentioned, the electrode voltages are not known, so the software has to intelligently guess when the voltages are likely to be near zero. The test that the software uses is to examine the mirror's position: if the mirror's position is within a critical threshold 106, then the electrode voltages are deemed to be near zero volts.

What the algorithm does when the electrode voltages are near zero volts depends on where the mirror's target position lies. When the desired movement of the mirror requires crossing from one side of zero angle to the other side, and does NOT require control near zero-angle, then the situation is simple to handle, and is reflected in FIG. 10a.

According to FIG. 10a, the starting mirror position 100 is negative and its target position 102 is positive. Hence, the mirror must cross the critical threshold 106. However, the ending target position 102 is well away from the zero-angle threshold region 106, so controlling the position near zero-angle is not required. In this situation, an off-zero algorithm is invoked as soon as the actual mirror position 101 crosses into the threshold region 106. Between the points 105 and 106, it simply drives the electrode that is on the target side of the mirror. In the case of FIG. 10a, the positive electrode would be driven.

A more complicated situation arises when the mirror's ending target position is within the critical near-zero threshold 106, as shown in FIG. 10b, in which case a near-zero algorithm is executed. It is important to appreciate that controlling the mirror's position around zero is difficult because the position of the mirror reported by the PDA may drift with time. This slack occurs over time even if the mirror's electrodes are held at substantially zero volts. Slack becomes noticeable during operation of the OXC after several minutes or after several days depending on the operational conditions of the OXC. Hence, positioning the mirror at angles very close to zero is difficult because which electrode to drive near the zero-volt position is ambiguous.

The near-zero algorithm is triggered if the mirror's target position 104 is within the threshold region 106 and if the mirror's actual position 103 is also within the threshold 106. Once the mirror orientation passes point 107, then the algorithm begins to execute a complex set of operations to maintain the mirror's position near zero. This part of the algorithm is complicated because the electrode voltage must be held near zero volts in order to maintain the mirror's position accurately. However, because the electrode voltage is not known, the controller runs the risk that the actual electrode voltage will drop to zero volts without the controller knowing it.

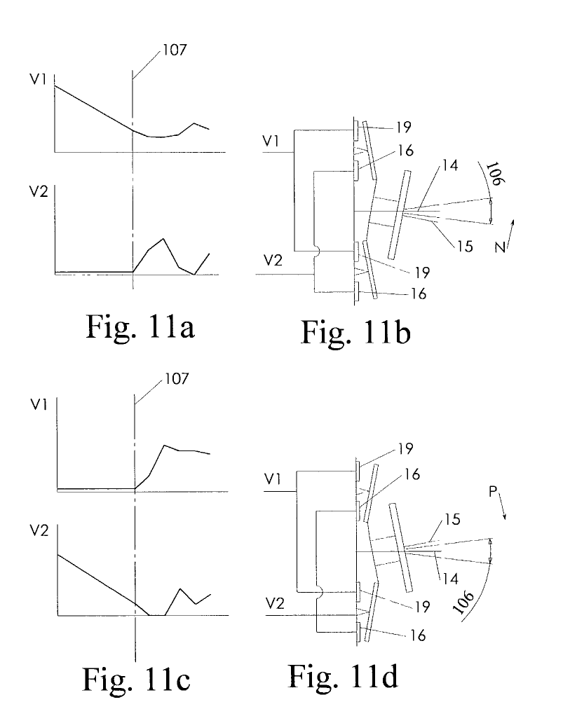

To maintain the mirror's position near zero angle, the zero-crossing algorithm intelligently drives opposing electrodes at the same time. The basic idea behind this part of the algorithm is to periodically discharge one electrode at a high rate. These discharges guarantee that the voltage on the electrode is identically zero volts. Between these resets, the voltage on the electrode can be accurately estimated and, with one electrode voltage approximately known, control can be achieved through and around the zero-volt mirror position. FIGS. 11a and 11c depict graphs for exemplary drive charges applied to the electrodes 16, 19 before and after point 107. The graphs of FIG. 11a apply to the case depicted in FIG. 11b where the mirror is moved with its normal 15 in negative direction and the target orientation 104 is positive as well. The graphs of FIG. 11c apply to the case depicted in FIG. 11d where the mirror is moved with its normal 15 in positive direction and the target orientation 104 is positive as well. Voltage V1, V2 are the drive charges applied to electrodes 19, 16.

Before giving a detailed explanation of this part of the algorithm, it is helpful to first convey certain concepts. One key concept that is a core part of this algorithm is the idea of a strong and weak electrode. Simply stated, the strong electrode is the one that will tend to have the higher voltage to maintain the mirror's position at its target value. If the mirror's target position is a positive angle, then the positive electrode is defined as the strong electrode, and the negative electrode is the weak electrode. In contrast, if the mirror's target position is negative, then the negative electrode is the strong electrode and the positive electrode is the weak electrode. Understanding these terms is important because the strong and weak electrodes are treated differently.

The processor 68 produces commands that represent changes in voltage that the zero-crossing algorithm uses as input. As has been mentioned, the algorithm splits the incoming command between the positive and negative electrodes of a mirror axis. The manner in which the controller's command is split depends on the numerical sign of the command.

For the sake of example, it may be assumed that the algorithm has determined that the positive electrode is the strong electrode, thus making the negative electrode the weak electrode. It may be further assumed that, at some point in time, the controller requests a negative change in electrode voltage. Since the positive electrode is the strong electrode and the requested delta-voltage is negative, then this is assumed to be a step toward the center of the threshold 106. If this is the case, then the change in mirror position is not achieved simply by decreasing the voltage on the positive electrode. Rather, it is achieved by both decreasing the voltage on the positive electrode and by increasing the voltage on the negative electrode as depicted in FIG. 11a. Specifically, the requested change in voltage is split unevenly: 90% of the requested voltage is implemented as an increase in the negative electrode voltage (which moves the mirror toward negative angles), and 10% of the requested voltage is implemented as a decrease in the positive electrode voltage. The net effect should be approximately equal to decreasing the positive electrode by 100% of the requested voltage change. The slope proportion of the curves for V1, V2 inside the threshold 106 corresponds to the 90/10 split.

During the execution of the algorithm, a running estimation of the weak electrode voltage is maintained. When, as in the previous example, the processor 68 requests a step toward the zero-angle position, the weak electrode voltage is increased. The amount by which it is increased (90% of the commanded voltage change) is added to the running estimation of the weak electrode voltage. Maintaining an estimate of the weak electrode voltage is important for reasons that will become apparent shortly. Suffice it to say, for now, that such an estimate is maintained while this part of the zero-crossing algorithm is active.

Continuing with the previous example, it may be assumed that, during the next time step, the processor 68 requests a positive change in voltage. If this is the case, then this is an indication that the controller wants to move the mirror away from the zero-angle position since the positive electrode is the strong electrode. In this case, the voltage command is again split between the positive and negative electrodes. However, the split is not the same as in the previous example i.e. a 90/10 split. For steps away from zero, the full voltage change is implemented as a decrease in the weak electrode voltage. If the requested voltage change is greater than the preferably estimated weak electrode voltage, then the weak electrode voltage is driven to zero volts, and the remaining voltage request is implemented as an increase in the strong electrode voltage.

To aid in the understanding of the algorithm, the following pseudocode has been included. This code implements the algorithm as described in the previous paragraphs. This code assumes that the zero-crossing algorithm has been triggered by both the target position and the mirror's actual position being near the zero-angle position 106. Furthermore, this code assumes that the positive electrode has been determined as the strong electrode. The objective of the code is to assign values to the two variables Positive_Electrode_Delta_Voltage and Negative_Electrode_Delta_Voltage, which represent the voltage command that is sent to the positive and negative electrodes, respectively. Note that the input to the algorithm is the controller's commanded voltage change i.e. the variable Requested_Delta_Voltage.

If Requested_Delta_Voltage<0.0 then this is a step toward zero

Decrease the strongside electrode voltage:

Positive_Electrode_Delta_Voltage=0.1*Requested_Delta_Voltage

Increase the weakside electrode voltage:

Negative_Electrode_Delta_Voltage=0.9*Requested_Delta_Voltage

Maintain a running estimate of the weak electrode voltage:

Weak_Electrode_Voltage_Estimate+=Negative_Electrode_Delta_Voltage

Else the Requested_Delta_Voltage is>0.0

This is a step away from zero.

In this situation, discharge the weak electrode.

First calculate how much voltage would be left on the weak electrode if we took the entire voltage command out of this electrode.

Remaining_Voltage=Weak_Electrode_Voltage_Estimate+Requested_Delta_Voltage

If Remaining_Voltage<0.0

The entire command can be taken out of the weak electrode.

Take all of the delta-v out of the weak electrode.

Negative_Electrode_Delta_Voltage=Requested_Delta_Voltage

Weak_Electrode_Voltage_Estimate=Remaining_Voltage

Positive_Electrode_Delta_Voltage=0.0

Else the weak electrode must be totally discharged

Decrease the voltage on the strong electrode:

Positive_Electrode_Delta_Voltage=Remaining_Voltage

Turn off the weak electrode altogether

Negative_Electrode_Delta_Voltage=Maximum command towards zero

Now we know that the weak electrode should be at zero volts.

Reset the weak electrode voltage estimate to zero volts:

Weak_Electrode_Voltage_Estimate=0.0

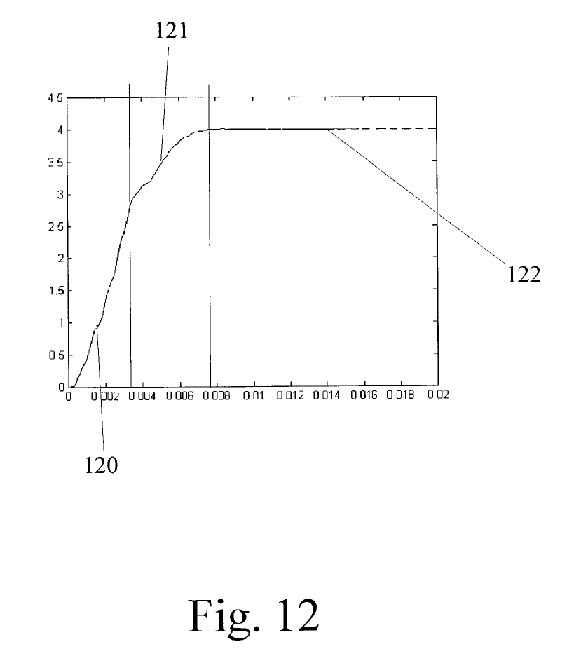

The control systems advanced performance is illustrated in FIG. 12. The graph shows an exemplary step response of a mirror operated with the control system of the present invention. As can be seen in FIG. 12 the mirror performs a spatial orientation change of about 4 degrees in less than 0.008 seconds. During an initial rapid move 120 the mirror is moved about 3 degrees in less then 0.004 seconds. In a following smooth deceleration phase 121 the mirror is brought into its new orientation 122 substantially without any overshoot.

Accordingly, the scope of the invention described in the specification above is set forth by the following claims and their legal equivalent.

What is claimed is:

1. A control system for controlling a mechanism including an electrostatic actuator actuating an optical device, said system comprising:
a. an off-zero actuation algorithm applied where a target position of said optical device is outside a movement range threshold of said mechanism;
b. a near-zero actuation algorithm applied where a said target position of said optical device is within a movement range threshold of said mechanism; and
wherein said movement range threshold corresponds to a mechanism slack occurring while said electrostatic actuator is substantially without charge.

2. The system of claim 1, wherein said optical device is a mirror.

3. The system of claim 1, wherein said optical device is part of an optical cross connect.

4. The system of claim 1, wherein said near-zero actuation algorithm initiates as soon as an actual position of said optical device is within said threshold during positioning of said optical device.

5. The system of claim 4, wherein said actual position is recognized by an optical feedback loop in which a beam is directed by said optical device corresponding to said actual position onto an optical detector such that an impinging coordinate is provided from which said actual position is computed.

6. The system of claim 1, wherein a derivative drive circuit provides a derivative charge to two opposing electrodes of said actuator and wherein said near-zero algorithm defines a strong actuator electrode for maintaining a high target voltage at said target position and a weak actuator electrode for maintaining a low target voltage at said target position.

7. A control system for controlling a mechanism having a non-linear actuation charge response, said mechanism including an electrostatic actuator actuating an optical device, said system comprising:
a. a look-up table;
b. a processor comprising:
i. a measurement function for deriving information about said non-linear actuation charge response by performing a position measurement of said optical device while a varying charge is applied to said actuator;
ii. a storing function for storing said information in said look-up table; and
c. a drive circuit for accessing said look-up table and applying said information to a received operational position command such that a corrected actuation charge is applied to said actuator, said actuation charge being compensated for said non-linear actuation charge response.

8. The system of claim 7, wherein said optical device is a mirror.

9. The system of claim 7, wherein said optical device is part of an optical cross connect.

10. The system of claim 7, wherein said position measurement is assisted by an optical feedback loop in which a beam is directed by said optical device onto an optical detector such that an impinging coordinate is provided from which said information is computed.

11. A control system for controlling a mechanism including an electrostatic actuator actuating an optical device, said system comprising:
a. a light source for directing a light beam towards said optical device such that a reflected beam is produced that corresponds to a spatial orientation of said optical device;
b. an optical detector for detecting an impinging coordinate of said reflected beam; and
c. a processor for providing an actuation signal to said electrostatic actuator in conjunction with said spatial orientation computed by said processor from said impinging coordinate.

12. The system of claim 11, wherein said optical device is a mirror.

13. The system of claim 11, wherein said optical device is part of an optical cross connect.

14. The system of claim 11, wherein said light source provides said light beam in a configuration such that said light beam is separated from a substantially collinear propagating optical telecommunication signal without substantially degrading said telecommunication signal.

15. The system of claim 14, wherein said beam configuration includes a first wavelength range that differs from a second wavelength range of said optical telecommunication signal.

16. A control system for controlling a mechanism including an electrostatic actuator actuating an optical device, said system comprising:
a. a light source for directing a light beam towards said optical device such that a reflected beam is produced that corresponds to a spatial orientation of said optical device;
b. an optical detector for detecting an impinging coordinate of said reflected beam;
c. a processor for selectively applying an off-zero actuation algorithm and a near-zero actuation algorithm in conjunction with a movement range threshold of said mechanism and in conjunction with said spatial orientation computed by said processor from said impinging coordinate; and
wherein said movement range threshold corresponds to a mechanism slack occurring while said electrostatic actuator is substantially without charge.

17. The system of claim 16, wherein said optical device is a mirror.

18. The system of claim 16, wherein said optical device is part of an optical cross connect.

19. The system of claim 16, wherein said light source provides said light beam in a configuration such that said light beam is separated from a substantially collinear propagating optical telecommunication signal without substantially degrading said telecommunication signal.

20. The system of claim 19, wherein said beam configuration includes a wavelength range that differs from a second wavelength range of said optical telecommunication signal.

21. The system of claim 16, wherein said near-zero actuation algorithm initiates as soon as an actual position of said optical device is within said threshold during positioning of said optical device.

22. The system of claim 21, wherein said actual position is recognized by an optical feedback loop in which a beam is directed by said optical device correspondingly to said actual position onto an optical detector such that an impinging coordinate is provided from which said actual position is computed.

23. The system of claim 16, wherein a derivative drive circuitry provides an derivative charge to two opposing electrodes of said actuator and wherein said near-zero algorithm defines a strong actuator electrode for maintaining a high target voltage at said target position and a weak actuator electrode for maintaining a low target voltage at said target position.

24. A control system for controlling a mechanism including an electrostatic actuator actuating an optical device and having a scale factor asymmetry, said system comprising:
a. a light source for directing a light beam towards said optical device such that a reflected beam is produced that corresponds to a spatial orientation of said optical device;
b. an optical detector for detecting an impinging coordinate of said reflected beam;
c. a derivative drive circuitry providing an derivative charge to said actuator; and
d. a processor for computing during an asymmetry calibration an asymmetry compensation factor from a change of said impinging coordinates while a set charge and a reset charge are periodically and alternately applied by said drive circuitry to said actuator.

25. A control system for simultaneously controlling an array of mechanisms, each of said mechanisms including an independent electrostatic actuator independently actuating one of an optical device array, said system comprising:
a. a light source for directing a light beam towards each of said optical devices such that an independently reflected beam is produced for each of said optical devices that corresponds to a spatial orientation of each of said optical devices;
b. an optical detector for detecting discrete impinging coordinates of each of said reflected beams; and
c. a processor for correspondingly assigning each of said discrete impinging coordinates to each of said optical devices in conjunction with said spatial orientations computed by said processor from said assigned impinging coordinates.

26. The system of claim 25, wherein said optical device array is a mirror array.

27. The system of claim 25, wherein said optical device array is part of an optical cross connect.

28. The system of claim 25, wherein a number of said light beam are sequentially directed towards each of said optical devices and wherein said optical detector sequentially detects said impinging coordinates.

29. The system of claim 25, wherein said light source provides said light beam in a configuration such that said light beam is separated from a substantially collinear propagating optical telecommunication signal without substantially degrading said telecommunication signal.

30. The system of claim 29, wherein said beam configuration includes a wavelength range that differs from a second wavelength range of said optical telecommunication signal.

31. A control system for simultaneously controlling in an optical cross connect an array of mechanisms, each of said mechanisms including an independent electrostatic actuator independently actuating one of an optical device array, said system comprising:
a. a laser device for sequentially combing a laser beam with a number of optical telecommunication signals each of them impinging at least one of said arrayed optical devices such that independently reflected beams are produced for each of said optical device array that corresponds to its spatial orientation, said reflected beams including said telecommunication signal and said laser beam;
b. an optical filter for filtering said laser beam from said reflected beam such that said telecommunication signal remains substantially free of attenuation;
c. an optical detector for sequentially detecting impinging coordinates of each of said reflected beams;
d. a processor for correspondingly assigning each of said sequentially detected impinging coordinates to each of said optical devices, for selectively providing an off-zero actuation algorithm and a near-zero actuation algorithm in conjunction with a movement range threshold of said mechanisms and in conjunction with said spatial orientations computed by said processor from said assigned impinging coordinates; and
wherein said movement range threshold corresponds to a mechanism slack occurring while said electrostatic actuator is substantially without charge.

32. The system of claim 31, wherein said optical device array is a mirror array.

33. The system of claim 31, wherein said near-zero actuation algorithm initiates as soon as an actual position of said optical device is within said threshold during positioning of said optical device.

34. The system of claim 33, wherein said actual position is recognized by an optical feedback loop in which a beam is directed by said optical device correspondingly to said actual position onto an optical detector such that an impinging coordinate is provided from which said actual position is computed.

35. The system of claim 31, wherein a derivative drive circuitry provides an derivative charge to two opposing electrodes of said actuator and wherein said near-zero algorithm defines a strong actuator electrode for maintaining, a high target voltage at said target position and a weak actuator electrode for maintaining a low target voltage at said target position.
